(19) United States
(12) Patent Application Publication
(10) Pub. No.: US 2005/0254469 A1
(43) Pub. Date: Nov. 17, 2005

(54) Wireless local area network (wlan) as a public land mobile network for wlan/telecommunications system interworking

(76) Inventors: Shaily Verma, Powai (IN); Charles Chuanming Wang, Jamison, PA (US); Kumar Ramaswamy, Princeton, NJ (US)

Correspondence Address: THOMSON LICENSING INC., PATENT OPERATIONS, PO BOX 5312, PRINCETON, NJ, 08543-5312, US

(21) Appl. No.: 10/511,641

(22) PCT Filed: Apr. 14, 2003
(86) PCT No.: PCT/US03/11450

§ 371 Date: Oct. 18, 2004

Related U.S. Application Data
(60) Provisional application No. 60/373,197, filed on Apr. 17, 2002.

(51) Int. Cl. H04Q 7/24

(52) U.S. Cl. 370/338

(57) ABSTRACT

A telecommunications system includes a Public Land Mobile Network for providing wireless service to users and a wireless local area network functioning outside the said PLMN as a separate PLMN. An inter-PLMN backbone interfaces the WLAN to the PLMN, and an interworking function is coupled to the WLAN to provide seamless interactions between the PLMN and the WLAN to increase available service bandwidth provided for users of the PLMN.

### FIELD OF THE INVENTION

The present invention generally relates to network communications and, more particularly, to a method and system for interworking wireless local area networks (WLAN) as a public land mobile network (PLMN) for WLAN-UMTS (universal mobile telecommunications system) communications.

### BACKGROUND OF THE INVENTION

Universal Mobile Telecommunications System (UMTS) is a ‘third generation’ (3G) mobile communications system developed within a framework known as IMT-2000 (International Mobile Telecommunications-2000). UMTS will play a key role in creating the mass market for high-quality wireless multimedia communications. UMTS will enable many wireless capabilities, delivering high-value broadband information, commerce and entertainment services to mobile users via fixed, wireless and satellite networks. UMTS will speed convergence between telecommunications, information technology, media and content industries to deliver new services and create revenue-generating services. In most instances, UMTS will deliver low-cost, high-capacity mobile communications with data rates up to the order of 2 Mbit/sec under stationary conditions with global roaming and other advanced capabilities.

One drawback of the UMTS network is high cost of spectrum and low data rates as compared to WLANs (Wireless Local Area Networks). It is thus advantageous to complement UMTS with unlicensed band, high data rate WLANs such as IEEE 802.11 and ETSI Hiperlan2 to save UMTS radio resources and increase the efficiency of the UMTS RAN (Radio Access Network).

Therefore, a need exists for a system and method, which utilizes WLAN bandwidth to supplement UMTS bandwidth to increase overall performance and efficiency. A further need exists for an architecture where the WLAN coverage area interacts with a UMTS network as another Public Land Mobile Network (PLMN) through an inter-PLMN backbone.

### SUMMARY OF THE INVENTION

A telecommunications system in accordance with the present invention includes a Public Land Mobile Network (PLMN) for providing wireless service to users, and a wireless local area network (WLAN) functioning outside the PLMN. An inter-PLMN backbone interfaces the WLAN to the PLMN, and an interworking function is coupled to the WLAN to provide seamless interactions between the PLMN and the WLAN to increase available service bandwidth provided for users of the PLMN.

In other embodiments, the PLMN may include SM/GMM (session management (SM)/GPRS mobility management (GMM)) procedures which are reused in the WLAN due to the use of an adaptation layer in a mobile dual-protocol stack and in the Interworking Function (IWF) to WLAN interface to mimic the functionality of an RRC (Radio Resource Control). The system may further include a GPRS tunneling protocol (GTP) tunnel between a GGSN and the IWF which is used only for downlink traffic coming from the GGSN to reduce system traffic. The system may include a single point of attachment to a service provider to serve the PLMN and attached WLANs to retain control over a customer base in the WLAN.

A method for increasing bandwidth of a Public Land Mobile Network (PLMN), includes connecting a wireless local area network (WLAN) to the PLMN through an inter-PLMN interface, and providing an interworking function, which communicates with the interface to convert protocols between the PLMN and the WLAN such that communications received from the WLAN appear to be from another UMTS/GPRS PLMN and communications sent to the WLAN appear to be from within the WLAN.

A method for employing a wireless local area network (WLAN) as a public land mobile network (PLMN) includes connecting a Universal Mobile Telecommunications System (UMTS) PLMN to a WLAN through an inter-PLMN backbone using a Gp interface providing interfaces toward the UMTS PLMN and the WLAN by employing an interworking function which provides protocol compatibility, and servicing users of the UMTS PLMN using the WLAN.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is a schematic diagram of a system architecture having a WLAN interfaced to a UMTS PLMN in accordance with one embodiment of the present invention;

FIG. 2 is an exemplary system diagram showing a WLAN interfaced to a UMTS PLMN, to be employed as a WLAN PLMN, in accordance with the present invention;

FIG. 3 is a user plane stack diagram showing an interworking function interface, which creates protocol compatibility between a WLAN mobile station and a UMTS PLMN in accordance with one embodiment of the present invention;

FIG. 4 is a control plane stack diagram showing an interworking function interface which creates protocol compatibility between a WLAN mobile station and a UMTS PLMN in accordance with one embodiment of the present invention; and

FIG. 5 is an illustrative diagram showing a routing area change between a WLAN and a UMTS PLMN in accordance with one embodiment of the present invention.

It should be understood that the drawings are for purposes of illustrating the concepts of the invention and are not necessarily the only possible configuration for illustrating the invention.

### DETAILED DESCRIPTION OF THE INVENTION

The present invention provides a method and system for utilizing available bandwidth in wireless/radio networks. An architecture is provided where the Wireless Local Area Network (WLAN) coverage area interacts with a Universal Mobile Telecommunications system (UMTS) network as another Public Land Mobile Network (PLMN) through an inter-PLMN backbone.

Roaming is employed between two PLMNs. A possible way to support inter-PLMN roaming is discussed very briefly in 3G TS 23.003 under the heading “Numbering, addressing and identification”. When a mobile station (MS), or user equipment (UE), roams from an SGSN (Serving GPRS Support Nodes) to an SGSN in another PLMN, the new SGSN may not have access to the address of the old SGSN. Instead, the SGSN transforms the old RA (radio access) information to a logical name. The SGSN may then acquire the IP address of the old SGSN from a domain name server (DNS), using the logical address (e.g., a logical SGSN). Every PLMN should include one DNS server.

Introducing the DNS concept in GPRS provides the possibility of using logical names instead of IP addresses when referring to, e.g., GPRS Support Nodes (GSNs), thus providing flexibility in addressing of PLMN nodes. Another way to support seamless inter-PLMN roaming is to store the SGSN IP addresses in HLR (home location register) and request the addresses when needed. TS 23003 states that a Public Land Mobile Network (PLMN) is uniquely identified by its PLMN identifier.

PLMN-Id is made of Mobile Country Code (MCC) and Mobile Network Code (MNC). According to the specifications, there can be places where MSs can receive two cells in different PLMNs, and there can exist overlapping PLMNs too. In such a case, the NAS (Non Access Stratum) may control the cell selection by maintaining lists of equivalent PLMNs and forbidden PLMNs. An Equivalent PLMN is a PLMN considered as equivalent to the selected PLMN by the UE for PLMN selection, cell selection, cell reselection and handover according to the information provided by the NAS. In the case, that the mobile has a stored “Equivalent PLMNs” list the mobile shall only select a PLMN if it is of a higher priority as the current serving PLMN, which are stored in the “Equivalent PLMNs” list. This list is replaced or deleted at the end of each location update procedure, routing area update procedure and GPRS attach procedure. Similarly, the MS shall contain a list of “forbidden PLMNs for GPRS service” where a Forbidden PLMN is a PLMN that the MS is not allowed to attach. The specification also states that as long as the new PLMN is not in the forbidden list, the MS shall initiate the normal routing area update procedure when moving from one PLMN's routing area to another PLMN's routing area.

A number of architectures are provided to interwork between the WLAN coverage area and other radio access technologies (RATs), such as UMTS. A novel approach is presented to assist in using any existing WLAN coverage area to complement UMTS networks by defining the WLAN as another PLMN and then using the inter-PLMN backbone to communicate between the WLAN and the UMTS network. The QoS (quality of service) negotiation, mobility, and AAA (Authentication, Authorization and Accounting) procedures of the 3G network are re-used. Anyone can own a WLAN. In other words, two heterogeneous interworking networks may not be owned by the same service provider. The present invention provides a means to support “roaming” capability from a logical-PLMN-based-WLAN to his home PLMN. Advantageously, the present invention can work with any two heterogeneous network systems (e.g., General Packet Radio Service (GPRS)/CDMA 2000, a DSL network, a cable network or a satellite network) that needs to interwork with each other using the inter PLMN roaming standards.

It is to be understood that the present invention is described in terms of an illustrative WLAN-UTMS UMTS system architecture; however, the present invention is much broader and may include any wireless/radio network system(s), which are capable of providing telecommunication services. It should be understood that the elements shown in the figures may be implemented in various forms of hardware, software or combinations thereof. Preferably, these elements are implemented in hardware on one or more appropriately programmed general-purpose devices, which may include a processor, memory and input/output interfaces.

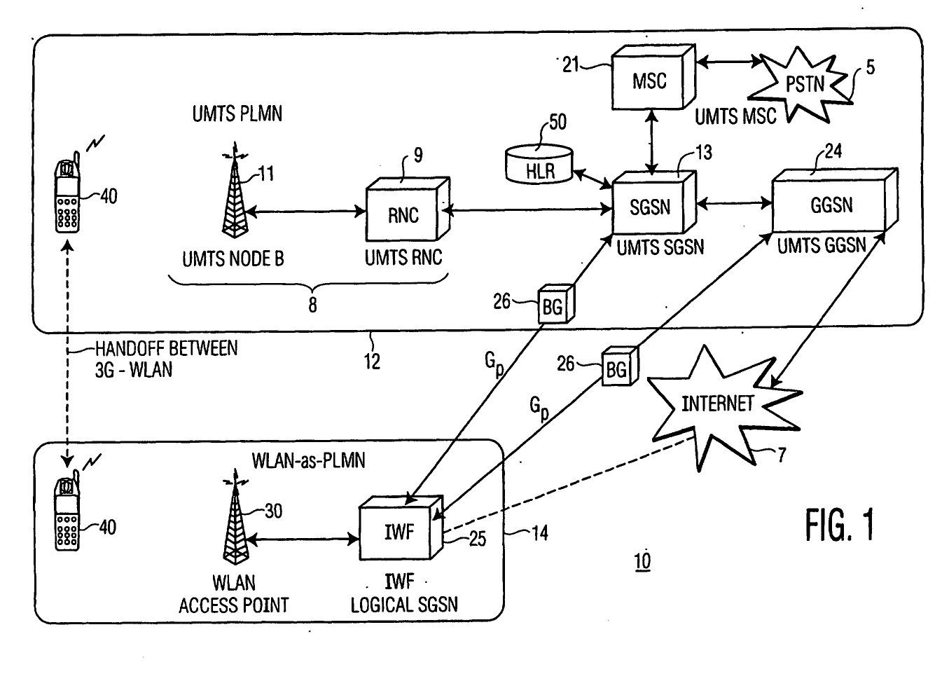

Referring now in specific detail to the drawings in which like reference numerals identify similar or identical elements throughout the several views, and initially to FIG. 1, a system architecture 10 for integrating voice, data, video and other services over wireless/radio networks is shown. System architecture 10 is presented as an exemplary WLAN-UMTS environment for employing the inventive method and system in accordance with the present invention. Details of the individual block components making up the system architecture which are known to skilled artisans will only be described in details sufficient for an understanding of the present invention.

The present invention is illustratively described in terms of a UMTS network 12 and a WLAN wireless network 14 (e.g., IEEE 802.11 and HIPERLAN2 standards may be employed by these networks). UMTS mobile network 12 (e.g., a third generation (3G) network) communicates with a radio access network (RAN) 8 which comprises a Node B 11 and Radio Network Controller (RNC) 9. The RAN 8 in turn is attached to a Core Network (CN) 13 which comprises packet based services such as a SGSN (Serving GPRS Support Node) 28, circuit based services, such as a MSC (Mobile Switching Center) 21 and gateways to other PLMNs, such as GGSN (Gateway GPRS Support Nodes) 24. Core network 13 supports connections/interfaces with public switched telephone networks (PSTN) 5 and the Internet 7.

Other components may be included in a core network 13. For example, a home location register 50 may be provided which stores the subscriber profile and authentication vectors of mobile stations (MS) 40. By the present invention, network 12 (e.g., a PLMN) is interfaced to a wireless LAN 14 through a G interface, called the Gp interface, using Border Gateway (BG) 26 and the inter-PLMN backbone network 18, by employing an interworking function 25. MS 40 connects at an access point 30, and MS 40 is seamlessly switched between WLAN 14 and UMTS 12 in accordance with the present invention when MS 40 roams between the radio access networks.

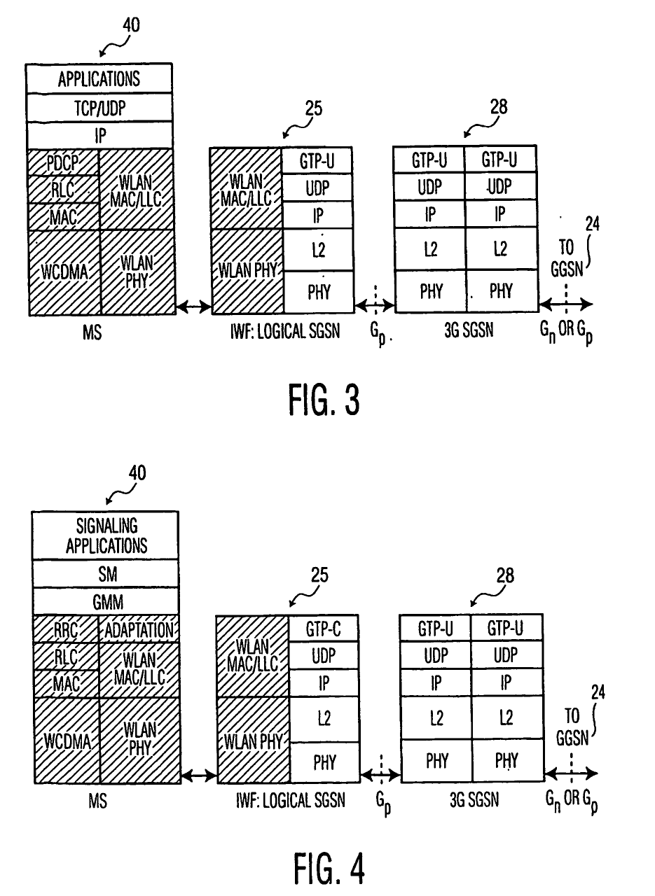

WLAN interworking function (IWF) 25 bypasses the RNC 9 and connects to SGSN 28 (assuming packet switched (PS) services). The GGSN 24 takes care of the mobility at the packet data (PD) layer, but the IWF 25 will need to communicate with the SGSN 28 to provide the mobility for the handoff between the two physical layer interfaces of network 12 and 14. This can be achieved by implementing the Gp interface between the IWF 25 and the SGSN 28 as shown in FIGS. 3 and 4. The 3G SGSN 28 then sees the IWF 25 as a ‘logical’ GGSN or pseudo-SGSN in another PLMN.

The SGSN (IWF)-GGSN portion may become a bottleneck in handling high data rate WLAN hotspots. In that case, another option is to use a GPRS tunneling protocol (GTP) tunnel 11 between GGSN 24 and IWF 25 is used only for downlink traffic coming from the GGSN 24 for user equipment (UE) at MS 40. For all other traffic, the WLAN 14 provides a common Internet access to the UE. This reduces the traffic through the SGSN-GGSN.

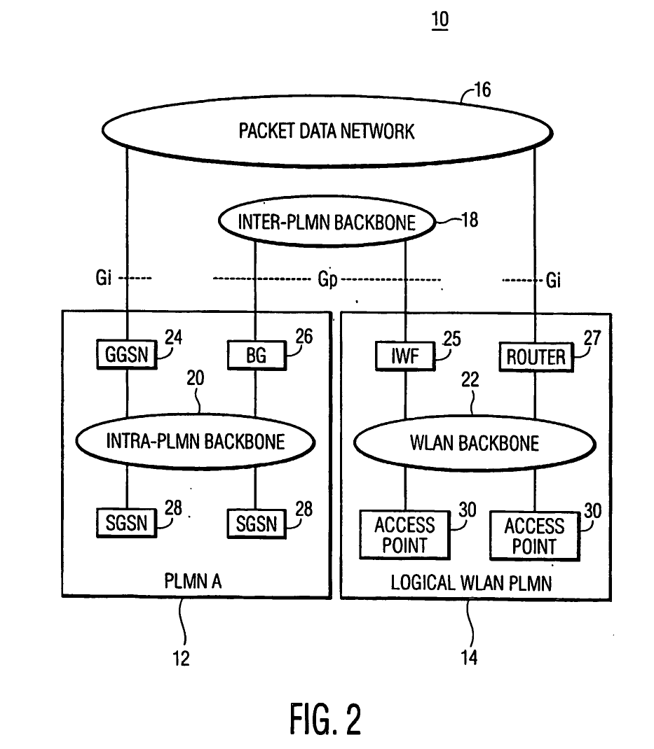

Referring to FIG. 2, in this example, there are two kinds of backbone networks. These are called lntra-PLMN backbone network 20 and Inter-PLMN backbone network 18. The intra-PLMN backbone network 20 preferably includes an Internet Protocol (IP) network interconnecting GSNs (Gateway Support Nodes) (not shown) within the same PLMN 12. The inter-PLMN backbone network 18 preferably includes a data packet (DP) network interconnecting GSNs and intra-PLMN backbone networks 18 in different PLMNs (e.g., PLMNs 12 and 14). Every intra-PLMN backbone network 18 is preferably a private DP network intended for packet domain data and signaling only. In accordance with the present invention, a WLAN backbone network 22 is employed as an intra-PLMN backbone.

Two intra-PLMN backbone networks 20 and 22 are advantageously connected via a Gp interface using a Border Gateway (BG) 26 and inter-PLMN backbone network 18. The inter-PLMN backbone network 18 is selected by a roaming agreement between providers or other default options, which may be programmed into the networks. The roaming agreement will also preferably include the BG 26 security functionality as well. The inter-PLMN backbone 18 may be included in Packet Data Network 16, e.g., the public Internet or a leased line, although other types of networks may be included.

WLAN PLMN 14 includes a plurality of access points 30 which are provided to permit wireless user equipment (UE) or mobile stations (MS) to access and use the WLAN. Such information may be transferred over Packet Data Network 16 by employing a router 27 and appropriate security and protocol interfaces (e.g., Gi).

By the present invention, WLAN 14 is implemented as another PLMN and an IWF (Interworking Function) 25 interacts with the UMTS network 12 through the inter-PLMN backbone 18 over the Gp interface. One approach in implementing this architecture includes treating the IWF 25 as a logical SGSN (similar to SGSNs 28), which communicates with an “old” SGSN in the UMTS PLMN over the Gp interface in a similar fashion as when an SGSN and/or a GGSN are in different PLMNs, and they are interconnected via the Gp interface. In this way, the UMTS PLMN 12 interfaces through IWF 25 in a WLAN environment as though the IWF 25 were an SGSN or GGSN in another PLMN. The Gp interface provides the functionality of the Gn interface, plus security functionality needed for inter-PLMN communication. The security functionality is based on mutual agreements between operators (e.g., between operators of the WLAN network 14 and the 3G (UMTS) network 12). The Gn interfaces interface between SSGNs and GGSNs of a same PLMN, while Gp interfaces interface between SSGNs and GGSNs of different PLMNs.

Referring to FIGS. 3 and 4, a user plane stack and a control plane stack for architecture 10 of FIG. 2 are illustratively shown. A logical SGSN or pseudo-SGSN is provided by IWF 25 to act as an interface. In this way, a mobile station (MS) 40 associated with a WLAN may interface with a SGSN 28 associated with a 3G UMTS PLMN 12 in accordance with the present invention. It is to be understood that the protocol stacks may be modified according to specific applications and roaming agreement (including security features) and the stacks shown are illustrative and for the purpose of demonstrating a particularly useful embodiment of the present invention. FIG. 3 illustrates user (data) plane stack protocol while FIG. 4 illustrates control/signaling stack protocol.

As one skilled in the art would understand, the user plane stack of MS 40 in FIG. 3 has a dual stack (WLAN and UMTS) which includes an Applications layer, a transmission control protocol/user datagram protocol (TCP/UDP) layer, an Internet protocol layer (IP), a WLAN medium access control/radio link control/logical link control (MAC/RLC/LLC) layer and the WLAN physical layer; the UMTS part also includes the packet data convergence protocol (PDCP), radio link control (RLC) and MAC layers, and a UMTS physical layer (PHY). The IWF 25 transfers any data/information received from the mobile over the WLAN interface to the UMTS network over an interface compatible with an SGSN of a 3G UMTS system. For example, the data received over WLAN MAC/LLC is transferred to the UMTS SGSN 28 by IWF 25 over a gateway tunneling protocol for the user plane (GTP-U), UDP and an IP.

Similar conversion is performed in the control plane. As one skilled in the art would understand, the control plane stack of MS 40 in FIG. 4 includes a common Signaling Applications layer, a session management layer (SM), a GPRS mobility management layer (GMM); an RRC (Radio Resource Control) layer, a RLC/MAC layer and the UMTS physical layer for the UMTS interface; and over the WLAN interface: an adaptation layer for radio resource control (RRC), a WLAN MAC/LLC layer, and a WLAN PHY layer. The adaptation layer (AL) in the MS 40 mimics the interface functions that correspond to the RRC service. This is necessary to reuse the session management (SM) and GPRS mobility management (GMM) layers of the 3G mobile stack even in WLAN. The IWF adaptation layer (AL) might play the role of a light RRC and transfer any control signaling information (SM/GMM messages) from the MS 40 received over the WLAN MAC/LLC layers to SGSN 28 over a protocol compatible with an SGSN of a 3G UMTS system and vice versa. As before, IWF 25 transfers SM/MM signaling over the Gp interface to the 3G SGSN, and may be employed as though stack were native to the 3G network.

The present invention provides at least the following advantages. The quality of service (QoS) negotiation, mobility, MA procedures of the 3G network are employed making the entire system more efficient from the standpoint of increased bandwidth, quality and compatibility. All cellular operators may share WLAN resources in hot spots where system resources may be taxed under normal traffic conditions. By instituting appropriate roaming agreements, any operator can “own” the WLAN and establish a trust relationship with a UMTS operator. In other words, a subscriber from any operator may have “roaming” capability from a logical-PLMN-based-WLAN to his home PLMN or other designated PLMN. The present invention can work with any system (GPRS/CDMA 2000) that can interwork with WLANs.

Advantageously, deployed WLANs, in accordance with the present invention, provide needed bandwidth to maintain QoS for all users. For example, 3G operators, instead of deploying their own WLANs in hotspots, may use existing WLANs already deployed to increase their network capabilities. In addition, WLAN radio resources may be used to free up radio resources of the 3G RAT that a user is moving in a WLAN coverage area. Communication between PLMNs and WLAN of the present invention is seamless by employing an IWF to create compatible protocols and information exchange.

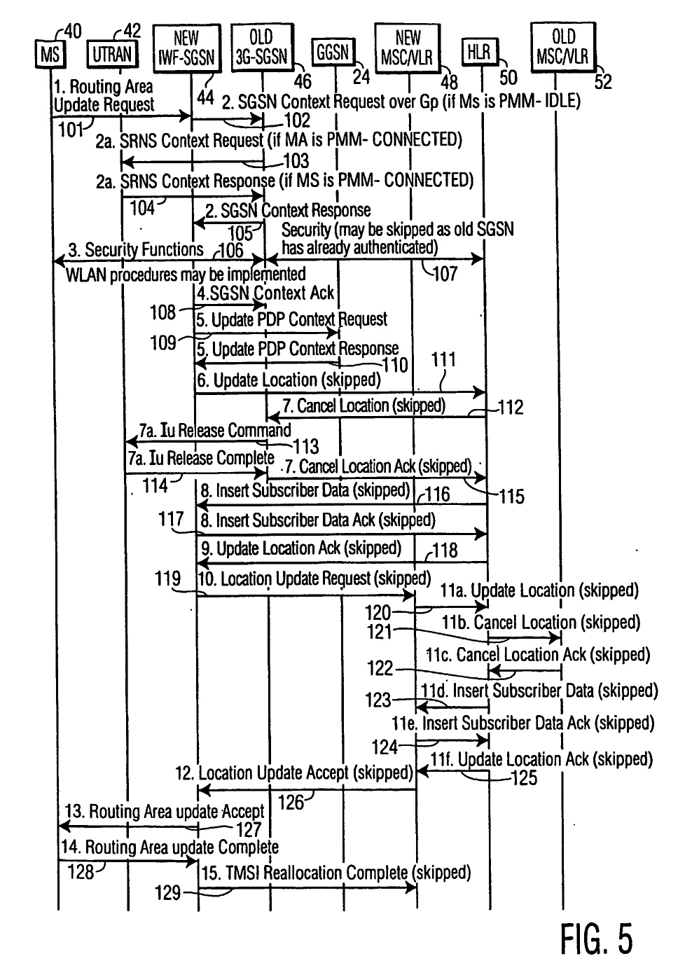

Referring to FIG. 5, a diagram showing interactions between entities in a routing area change scenario are illustratively shown in accordance with one example embodiment of the present invention. The diagram shows a mobile station (MS) 40, a UMTS Terrestrial Radio Access Network (UTRAN) 42, a new IWF-SGSN 44 (created to employ the resources of a WLAN), an old 3G-SGSN 46, a GGSN 24, a new mobile switching center/visitor location register (MSC/VLR) 48, a home location register (HLR) 50 and an old MSC/VLR 52. In this scenario, MSis moving into a high traffic area (hot spot) where a UMTS' resources are heavily loaded. The system employs the WLAN (IWF) to more efficiently use the resources of the 3G UMTS supplementing its capabilities with the WLAN. In step 101, a routing area update request is made by MS 40 to the IWF-SGSN 44. If MSis in packet mobility management (PMM) idle, IWF-SGSN 44 makes a context request over a Gp interface to old 3G SSGN 46 to perform a routing area update, in step 101. If in idle mode, IWF 44 sends an SGSN Context Request in step 102 to SGSN 46. SGSN 46 provides a context response to IWF-SGSN 44 in step 105. If MS 40 is in a PMM connected mode, an SRNS (Serving Radio Network Subsystem) context response is made to UTRAN 42 in step 103 and a response is sent back to 3G-SGSN 46 in step 104.

When a subscriber is in a WLAN coverage area, security functions may be handled between MS 40 and IWF-SGSN 44 in step 106 in the same way as if it were in a UMTS coverage area. Additional security procedures may be provided in step 107 to authenticate the new IWF-SGSN 44. In step 108 a context acknowledgement is sent from IWF-SGSN 44 to SGSN 46. In step 109, IWF-SGSN 44 sends a packet data protocol context request to GGSN 24, which responds with a context response in step 110.

When MS 40 roams from an SGSN 46 to an SGSN 44 in another PLMN, the new SGSN 44 may not have access to the address of the old SGSN 46. Instead, the SGSN 44 may transform the old RA information to a logical name. The SGSN may then acquire the IP address of the old SGSN from a domain name (DNS) server, using the logical address. Every PLMN should include one DNS server. Introducing the DNS concept in GPRS provides the possibility of using logical names instead of IP addresses when referring to, e.g., GSNs, thus providing flexibility in addressing of PLMN nodes. Another way to support seamless inter-PLMN roaming is to store the SGSN IP addresses in HLR (home location register) 50 and request the addresses when needed.

Mobility

The WLAN has all the operational functions as an independent PLMN to support inter PLMN roaming. The WLAN can be included in the “equivalent PLMN” list of the MS at the time of attaching by the 3G network with a higher priority so that when there is a WLAN coverage overlapping with a UMTS coverage PLMN, the WLAN PLMN is chosen by the MS. In steps 111-120, the new SGSN (IWF 25) 44 informs the HLR 50 of the change of SGSN by sending Update Location (SGSN Number, SGSN Address, and International Mobile Subscriber Identification (IMSI)) to the HLR 50. Requests, responses and acknowledgements are performed. Steps 111 and 114 perform a Iu (interface between RNC and SGSN) release sequence when MS 40 sends an explicit signaling connection release to UTRAN 42 upon being validated by the old SGSN 46 in steps 102-105 depending on a Packet Mobile Management (PMM) state of MS 40. A similar procedure is performed to update location in the visitors location register VLR between an old VLR/MSC 52 and a new VLR/MSC 48. Steps 120-125 provide this update sequence.

The new SGSN (IWF) 44 may not implement a Gr interface (an interface between an HLR and an SGSN) with HLR 50 and so, in this case, steps 111-126 and 129 may be skipped. In step 126, a location update accept is sent to IWF SGSN 44 from the new VLR/MSC 48. The routing area change is updated, accepted in step 127 and completed in step 128. In step 129, PTMSI (Packet Temporary Mobile Subscriber Identity) reallocation may be performed and completed if needed.

The IWF is referred to as IWF 25 (FIGS. 1 and 2), and the IWF-SGSN 44 is employed to indicate the system's interface location. These terms are synonymous and may be readily interchanged. The method as described with reference to FIG. 5 illustratively describes the following scenario.

1. UMTS to WLAN Entry

If the UMTS SGSN covers one routing area (RA) and the WLAN coverage area is another RA, the WLAN IWF can broadcast the new routing area identifier (RAI) (pre-allocated by the UMTS network). By comparing the RAI stored in user equipment (UE) or mobile station (MS) in GPRS Mobile Management (GMM) context with the RAI received from the IWF, the MS or UE detects that an RA update (inter-SGSN) needs to be performed. The procedure is described with reference to FIG. 5. For an Inter-SGSN RA update, the new SGSN (IWF) informs the HLR of the change of SGSN by sending Update Location (SGSN Number, SGSN Address, and International Mobile Subscriber Identification (IMSI)) to the HLR. However, in the described case of FIG. 5, the new SGSN (IWF) may not implement the Gr interface towards HLR and so this step along with the other identified steps are skipped. The Iu release sequence happens when the UE sends an explicit signaling connection release to a UMTS Terrestrial Radio Access Network (UTRAN) upon being validated by the old SGSN depending on a Packet Mobile Management (PMM) state of the UE.

2. WLAN to UMTS Entry

Upon re-entry into the UMTS network, the UE again performs an inter-SGSN routing area update and repeats the method of FIG. 5, except that this time the new SGSN is the UMTS SGSN while the old SGSN is the IWF. 3G security procedures are preferably implemented to re-validate the UE when it goes back to the UMTS network. If in going into the WLAN, the IWF had not updated the HLR and the UMTS SGSN marked in its context a Mobile Switching Center (MSC)/Visitor Location Register (VLR) association, the information in the GGSNs and the HLR is invalid, so when the MS initiates a routing area update procedure back to the UMTS SGSN, it triggers the MSC/VLR, the GGSNs, and the HLR information in the UMTS SGSN to be updated/validated.

Security

Advantageously, 3G security procedures may be reused to validate the UE when it moves to WLAN using the HLR interface with the 3G SGSN. However, additional security functionality required for inter-PLMN communication will be needed.

By the present invention, dual stacked mobile units and an IWF employ an adaptation layer (AL) which enables the ability to use existing SM/GMM procedures from the mobile to the 3G SGSN for Session and Mobility management. The invention advantageously reuses the SM/GMM procedures of UMTS even in the WLAN due to the use of an AL in the mobile dual-protocol stack and in the IWF WLAN interface to mimic the functionality of a light RRC. The service provider requires only one point of attachment to serve the 3G network as well as the attached WLANs helping the provider retain tight control over his customer base in the WLAN as well. The present invention also has the advantage that the dual GTP encapsulation as in the UMTS network (GGSN-SGSN and then SGSN-RNC) is avoided as only the GGSN-IWF encapsulation part is done in the WLAN coverage area. No modifications to the existing UMTS network nodes are required for the interworking architecture of the present invention, and seamless handover is provided (e.g., no dropping of a session).

Having described preferred embodiments for wireless local area network (WLAN) as a public land mobile network for WLAN/Universal Mobile Telecommunications System interworking (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

1. A wireless Local Area Network (WLAN), comprising:
an access point for communicating with a plurality of mobile stations; and
an interworking function, coupled between the access point and a selected Public Land Mobile Network (PLMN), via an inter-PLMN backbone, the interworking function enabling communications between the selected PLMN and the WLAN wherein the WLAN appears as another PLMN to the selected PLMN.

2. The WLAN according to claim 1, wherein the interworking function enables communications with the selected PLMN using the Gp interface.

3. The WLAN according to claim 2, wherein the interworking function performs the functions of a logical Serving General Packet Radio Service (GPRS) Support Node (SGSN).

4. The WLAN according to claim 3, wherein the interworking function is viewed by the selected PLMN as an SGSN in another UMTS/GPRS PLMN.

5. The WLAN according to claim 1, wherein the selected PLMN includes Session Management/GPRS mobility management (SM/GMM) procedures, which are reused in the WLAN by the use of an adaptation layer in a mobile dual-protocol stack and in the IWF to WLAN interface to mimic the functionality of a Radio Resource Control (RRC) protocol sub-layer.

6. The WLAN according to claim 1, wherein the interworking function utilizes a GPRS tunneling protocol between a GGSN and the interworking function for downlink traffic coming from the GGSN to reduce UMTS traffic, and provides a common Internet access to all users for all other traffic to reduce the traffic between the interworking function and the GGSN.

7. The WLAN according to claim 1, wherein the selected PLMN comprises a Universal Mobile Telecommunications System (UMTS) network.

8. A method for communicating with a selected Public Land Mobile Network (PLMN) via a wireless Local Area Network (WLAN), comprising the steps of:
connecting the WLAN to the selected PLMN through an inter-PLMN interface; and
providing an interworking function, which communicates with the interface to convert protocols between the WLAN and the selected PLMN wherein communications from the WLAN to the selected PLMN appear to be from another PLMN, and communications from the selected PLMN to the WLAN appear to be from within the WLAN.

9. The method according to claim 8, wherein the providing step comprises providing an interworking function that communicates between the selected PLMN and the WLAN using the Gp interface.

10. The method according to claim 8, wherein the providing step comprises providing an interworking function that mimics the functions of a Serving General Packet Radio Service (GPRS) Support Node (SGSN).

11. The method according to claim 8, further comprising utilizing a GPRS tunneling protocol between a GGSN and the interworking function for downlink traffic coming from the GGSN to reduce traffic on the selected PLMN.

12. The method according to claim 8, further comprising an adaptation layer in a mobile dual-protocol stack in the interworking to WLAN interface to mimic the functionality of a Radio Resource Control (RRC) protocol sub-layer, whereby the session management/GPRS mobility management (SM/GMM) procedures are reused in the WLAN.

13. A method for communicating with a mobile station and a selected Public Land Mobile Network (PLMN) in a wireless Local Area Network (WLAN), comprising the steps of:
broadcasting a routing area identifier;
receiving a routing area update request from the mobile station that enters into a coverage area of the WLAN in response to the broadcast;
transmitting the routing area update request to a SGSN of a selected PLMN, via an inter-PLMN backbone using the Gp interface, wherein the WLAN appears as a logical PLMN to the selected PLMN; and
receiving a context response from the SGSN via the inter-PLMN backbone.

14. The method according to claim 13, wherein the selected PLMN comprises a Universal Mobile Telecommunications System (UMTS) network.

15. The method according to claim 13, further comprising the step of providing an interworking function that mimics the functions of a Serving GPRS Support Node (SGSN) such that the WLAN appears as another PLMN to the selected PLMN.
